(19) United States
(12) Patent Application Publication
(10) Pub. No.: US 2015/0297320 A1
(43) Pub. Date: Oct. 22, 2015

(54) IMPLANT HAVING A BONE GROWTH POWDER/BIOMEDICAL FILLER ROTARY PUSH STRUCTURE

(71) Applicant: STAR GENERATION LIMITED TAIWAN BRANCH, Taipei City (TW)

(72) Inventor: Chun-Leon CHEN, New Taipei City (TW)

(73) Assignee: STAR GENERATION LIMITED TAIWAN BRANCH, Taipei City (TW)

(21) Appl. No.: 14/254,915

(22) Filed: Apr. 17, 2014

(51) Int. Cl. A61C 8/00; A61C 8/02

(52) U.S. Cl. CPC A61C 8/0024; A61C 8/0006

(57) ABSTRACT

An implant includes an implant base having a predetermined diameter, a positioning thread spirally upwardly extended around the periphery thereof and gradually reducing in width in direction from the implant root toward an opposing top side thereof to form a gum-drilling structure, a plurality of spiral grooves equiangularly and upwardly extending around the periphery thereof across the positioning thread to form a plurality of cutting edges at the positioning thread at different elevations, and an arc top located at the top side thereof. The diameter of the implant root and the number of the spiral grooves are determined subject to a predetermined ratio so that the implant can be conveniently and rapidly driven into the dental bone to simultaneously propel the applied bone growth powder/biomedical filler into place, assuring a high level of implant reliability.

### BACKGROUND OF THE INVENTION

1. Field of the Invention

The present invention relates to dental implant technology and more particularly, to an implant having a bone growth powder/biomedical filler rotary push structure that can be conveniently and rapidly driven into the dental bone to simultaneously propel the applied bone growth powder/biomedical filler into place, assuring a high level of implant reliability.

2. Description of the Related Art

After a dental implant, lateral torque acted upon the implant can increase stress levels. Therefore, the angle of implant implantation direction is very important. Further, the thickness of the cortical bone is also an important factor in a dental implant procedure. Increasing the cortical bone thickness can reduce the stress value around the implant. Therefore, in a typically dental implant procedure, prior to installation of the dental implant, the dentist will check the conditions of the gum. If the thickness of cortical bone is insufficient, a bone growth powder/biomedical filler must be supplemented to lift the thickness of the cortical bone. The existing method is to lift the thickness of the cortical bone is achieved by making a drill hole in the cortical bone by osteotomy, and then filling a bone growth powder/biomedical filler into the drill hole, so as to increase the thickness of the cortical bone and to facilitate the follow-up implant installation procedure.

An early bone growth powder/biomedical filler filling tool for dental implant comprises a push pin at the end of a handle for pushing the applied bone growth powder/biomedical filler from the drill hole in the cortical bone. However, this bone growth powder/biomedical filler filling tool is not convenient to operate. It takes much time to fill the applied bone growth powder/biomedical filler into the crevice between the cortical bone and the sinus floor with this design of bone growth powder/biomedical filler filling tool. Operating this bone growth powder/biomedical filler filling tool is a big burden to the dentist and can make the patient feel uncomfortable.

In an advanced dental implant surgery, an improved design of implant capable of propelling the applied bone growth powder/biomedical filler can be used to help the dentist reduce fatigue and shorten the period the patients feel uncomfortable.

An implant capable of pushing the applied bone growth powder/biomedical filler into place generally has spiral grooves for cutting the bone and propelling the applied bone growth powder/biomedical filler. However, because the dental bone has different widths at different locations, implanting different sizes of implants having the same bone growth powder/biomedical filler propelling structure at different width locations at the dental bone can seriously affect the ease of implantation and the degree of implant appropriateness.

### SUMMARY OF THE INVENTION

The present invention has been accomplished under the circumstances in view. It is one object of the present invention to provide an implant that can be conveniently and rapidly driven into the dental bone to simultaneously propel the applied bone growth powder/biomedical filler into place, assuring a high level of implant reliability.

To achieve this and other objects of the present invention, an implant in accordance with the present invention comprises an implant base having a predetermined diameter, a positioning thread spirally upwardly extended around the periphery thereof and gradually reducing in width in direction from the implant root toward an opposing top side thereof to form a gum-drilling structure, a plurality of spiral grooves equiangularly and upwardly extending around the periphery thereof across the positioning threads to form a plurality of cutting edges at the positioning thread at different elevations, and an arc top located at an opposing top side thereof, wherein the ratio between the diameter of the implant root and the number of the spiral grooves is in the range of 1.2˜2.0.

Preferably, the diameter of the implant root is in the range of 3˜7 mm; the number of the spiral grooves is within 2˜4. In one embodiment of the present invention, the diameter of the implant root is 3.75 mm, the number of the spiral grooves is 2, and therefore the ratio between the diameter of the implant root and the number of the spiral grooves is 1.875.

In another embodiment of the present invention, the diameter of the implant root is 4.5 mm, the number of the spiral grooves is 3, and therefore the ratio between the diameter of the implant root and the number of the spiral grooves is 1.5.

In still another embodiment of the present invention, the diameter of the implant root is 5.25 mm, the number of the spiral grooves is 4, and therefore the ratio between the diameter of the implant root and the number of the spiral grooves is 1.3125.

Further, the positioning thread and the spiral groove can extend in the same direction, or alternatively in reversed directions.

### BRIEF DESCRIPTION OF THE DRAWINGS

FIG. 1 is an oblique top elevational view of an implant in accordance with a first embodiment of the present invention.

FIG. 2 is a front view of the implant shown in FIG. 1.

FIG. 3 is a top view of the implant shown in FIG. 1.

FIG. 4 is a sectional view taken along line 3-3 of FIG. 3.

FIG. 5 is a front view of an implant in accordance with a second embodiment of the present invention.

FIG. 6 is a top view of the implant shown in FIG. 5.

FIG. 7 is a front view of an implant in accordance with a third embodiment of the present invention.

FIG. 8 is a top view of the implant shown in FIG. 7.

FIG. 9 is a schematic drawing illustrating different alternate forms of implants constructed in accordance with the present invention and installed in different bone width locations.

FIG. 10 is an oblique top elevational view of an implant in accordance with a fourth embodiment of the present invention.

### DETAILED DESCRIPTION OF THE PREFERRED EMBODIMENT

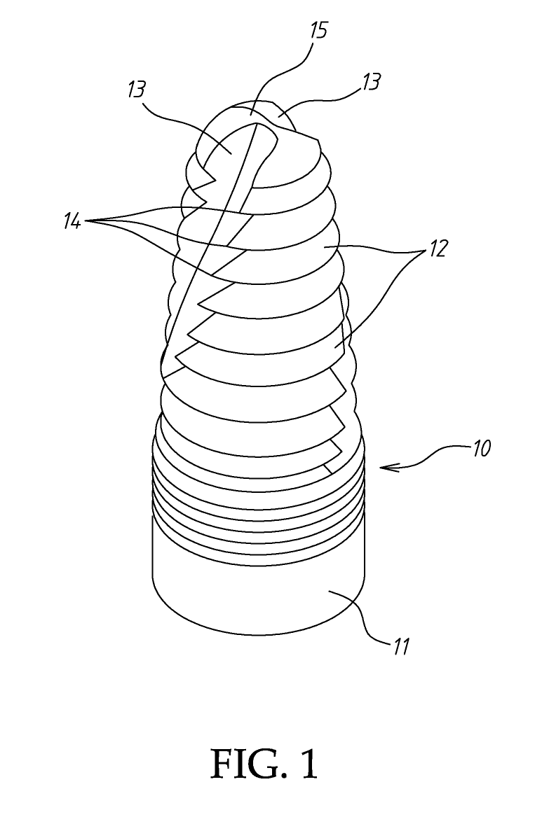

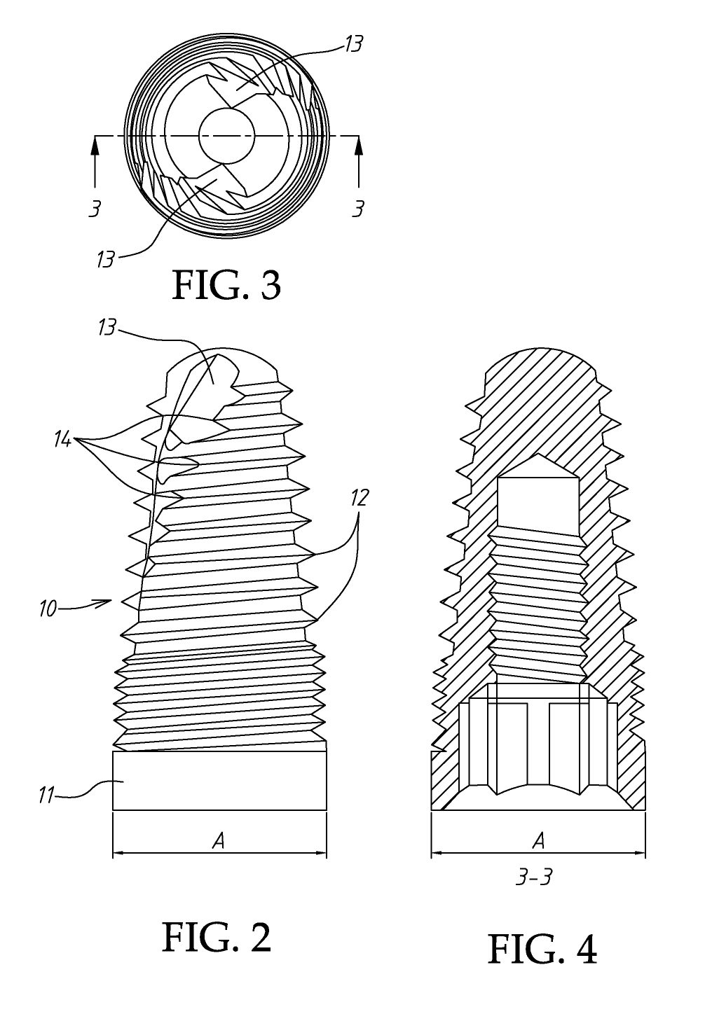

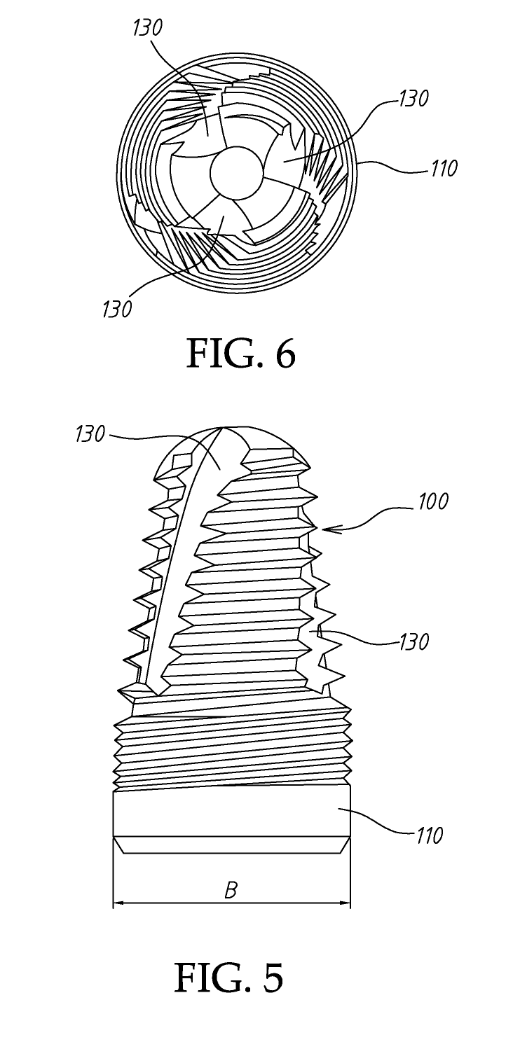

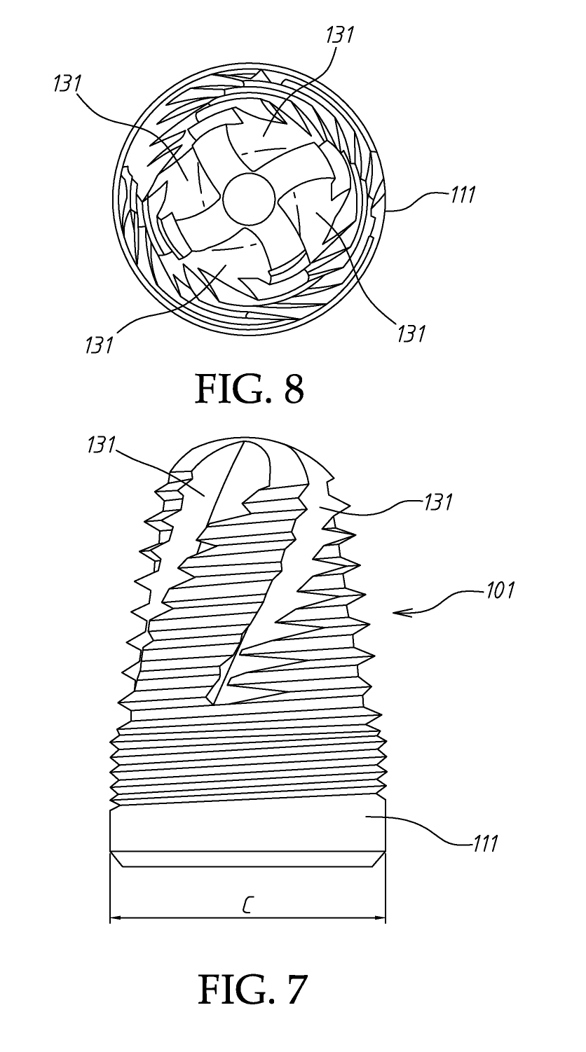

Referring to FIGS. 1-4, an implant 10 in accordance with a first embodiment of the present invention is shown. The multi-size implant 10 is prepared from zirconium dioxide, comprising an implant root 11 located at a bottom side thereof. The implant root 11 has a predetermined diameter A in the range of 3 mm-7 mm to fit different dental widths. The diameter A of the implant root 11 in this first embodiment is 3.75 mm. The diameter B of the implant root 110 in a second embodiment of the present invention as shown in FIGS. 5 and 6 is 4.5 mm. The diameter C of the implant root 111 in a third embodiment of the present invention as shown in FIGS. 7 and 8 is 5.25 mm. These embodiments are designed for explanation only but not intended for use to limit the scope of the present invention.

Referring to FIGS. 1-4 again, the multi-size implant 10 comprises the aforesaid implant root 11 at the bottom side thereof, a positioning thread 12 spirally upwardly extended around the periphery thereof and gradually reducing in width in direction from the implant root 11 toward an opposing top side thereof to form a gum-drilling structure, a plurality of, for example, two spiral grooves 13 equiangularly and upwardly extending around the periphery thereof across the positioning threads 12 to form a plurality of cutting edges 14 at the positioning thread 12 at different elevations, and an arc top 15 located at the top side thereof. The implant 10 can be driven by a tool (not shown) and positioned in the cortical bone and simultaneously propel the applied bone growth powder/biomedical filler. In this embodiment, the positioning thread 12 and the spiral groove 13 spirally extend in the same direction. In this embodiment, the positioning thread 12 spirally extends around the periphery of the implant 10 from the top side toward the implant root 11 in clockwise direction, and the spiral groove 13 also extends spirally downwardly in clockwise direction.

The main characteristic of the present invention is that the ratio between the diameter A of the implant root 11 of the implant 10 and the number of the spiral grooves 13 is in the range of 1.2˜2.0. In this first embodiment, the diameter A of the implant root 11 is 3.75 mm, the number of the spiral grooves 13 is 2, and therefore the ratio between the diameter A of the implant root 11 of the implant 10 and the number of the spiral grooves 13 is 1.875.

In the second embodiment of the present invention, as shown in FIGS. 5 and 6, the diameter B of the implant root 110 is 4.5 mm, the number of the spiral grooves 130 is 3, and therefore the ratio between the diameter B of the implant root 110 of the implant 100 and the number of the spiral grooves 130 is 1.5.

In the third embodiment of the present invention, as shown in FIGS. 7 and 8, the diameter C of the implant root 111 is 5.25 mm, the number of the spiral grooves 131 is 4, and therefore the ratio between the diameter C of the implant root 111 of the implant 101 and the number of the spiral grooves 131 is 1.3125.

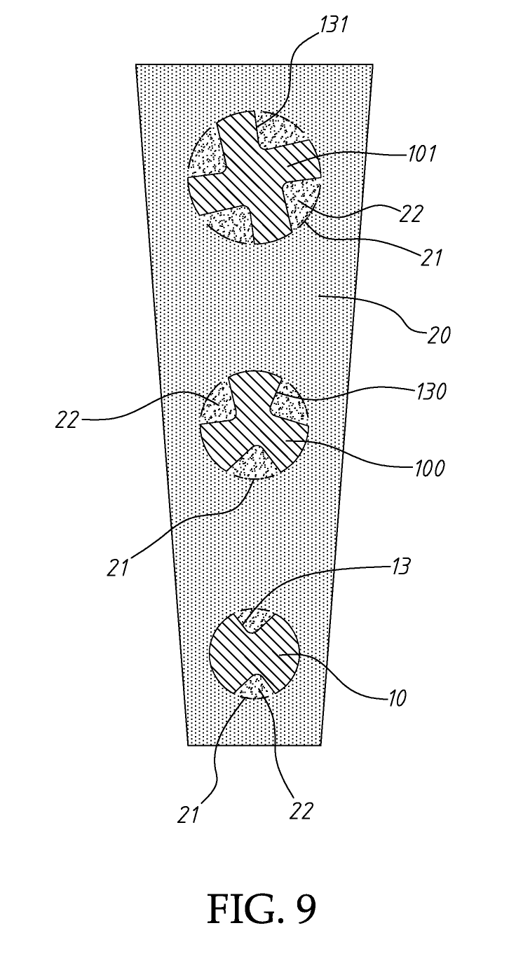

Referring to FIG. 9, different sizes of implants 10, 100, 101 having different numbers of spiral grooves 13, 130, 131 can be driven into respective drill holes 21 that are made by osteotomy in the dental bone 20 at different bone width locations. Subject the design of the spiral grooves 13, 130, 131 and arc top 15, the applied bone growth powder/biomedical filler 22 is simultaneously pushed into place.

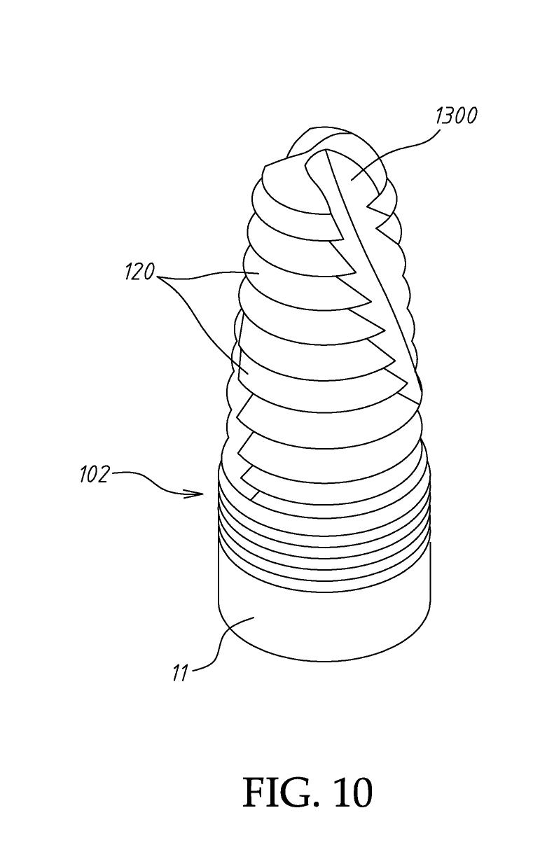

Referring to FIG. 10, an implant 102 in accordance with a fourth embodiment of the present invention is shown. In this fourth embodiment, the positioning thread 120 and the spiral grooves 1300 extend in reversed directions, i.e., if the positioning thread 120 shown in the drawing extends spirally downwardly in clockwise direction, the spiral groove 1300 extends spirally downwardly in counter-clockwise direction. Thus, when driving the implant 102 into the dental bone, the positioning thread 120 imparts a further propelling force in the direction of the implantation.

The implants 10, 100, 101 have different numbers of spiral grooves 13, 130, 131 and can be installed in the dental bone at different bone width locations to provide different numbers of spiral channels and cutting edges 14, facilitating quick and accurate implant positioning and bone growth powder/biomedical filler propelling, and assuring a high level of implant reliability.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An implant, comprising an implant base having a predetermined diameter, a positioning thread spirally upwardly extended around the periphery thereof and gradually reducing in width in direction from said implant root toward an opposing top side thereof to form a gum-drilling structure, a plurality of spiral grooves equiangularly and upwardly extending around the periphery thereof across said positioning thread to form a plurality of cutting edges at the positioning thread at different elevations, and an arc top located at the top side thereof, the ratio between the diameter of said implant root and the number of said spiral grooves being in the range of 1.2˜2.0.

2. The implant as claimed in claim 1, wherein the diameter of said implant root is in the range of 3˜7 mm; the number of said spiral grooves is within 2˜4.

3. The implant as claimed in claim 1, wherein the diameter of said implant root is 3.75 mm, the number of said spiral grooves is 2, and therefore the ratio between the diameter of said implant root and the number of said spiral grooves is 1.875.

4. The implant as claimed in claim 1, wherein the diameter of said implant root is 4.5 mm, the number of said spiral grooves is 3, and therefore the ratio between the diameter of said implant root and the number of said spiral grooves is 1.5.

5. The implant as claimed in claim 1, wherein the diameter of said implant root is 5.25 mm, the number of said spiral grooves is 4, and therefore the ratio between the diameter of said implant root and the number of said spiral grooves is 1.3125.

6. The implant as claimed in claim 1, wherein said positioning thread and said spiral groove extend in the same direction.

7. The implant as claimed in claim 1, wherein said positioning thread and said spiral groove extend in reversed directions.
